(19) United States
(12) Patent Application Publication
(10) Pub. No.: US 2026/0318384 A1
(43) Pub. Date: Oct. 15, 2026

(54) AXIALLY DAMPING HYDRAULIC MOUNT

(71) Applicant: VORWERK AUTOTEC GMBH & CO. KG, Wuppertal (DE)

(72) Inventors: Lothar SCHAUMANN, Ratingen (DE); Youchao XIONG, Suzhou City (CN); Wolfgang SCHMITT, St. Augustin (DE)

(21) Appl. No.: 19/641,616

(22) Filed: Apr. 8, 2026

(30) Foreign Application Priority Data
Apr. 9, 2025 (DE) 10 2025 114 047.2

(51) Int. Cl. F16F 13/10; B60K 5/12

(52) U.S. Cl. CPC F16F 13/10; B60K 5/1208

(57) ABSTRACT

An axially damping hydraulic mount, comprising a mount core extending in a longitudinal direction, an outer sleeve, and an elastomer body arranged radially between the mount core and the outer sleeve, the mount core and the elastomer body delimiting at least two liquid chambers that are associated with one another and are filled with a damping liquid, and the liquid chambers that are associated with one another being fluidically connected by at least one damping duct, which is provided at least in portions in a duct shell arranged between the elastomer body and the outer sleeve. The mount core comprises at least two mount core elements that are in succession in the longitudinal direction, and, in a longitudinal section of the hydraulic mount, an associated, axially and radially extending elastomer suspension spring arm of the elastomer body and an axially and radially extending elastomer expanding spring arm of the elastomer body each extending from both mount core elements, and the duct shell being configured and designed to axially and radially receive a respective free end portion of the expanding spring arms of the two mount core elements to fix the free end portions of the expanding spring arms relative to one another.

### FIELD

The invention relates to a hydraulically damping mount, comprising a mount core extending in a longitudinal direction, an outer sleeve, and an elastomer body arranged radially between the mount core and the outer sleeve, the mount core and the elastomer body delimiting at least two liquid chambers that are associated with one another and are filled with a damping liquid, and the liquid chambers that are associated with one another being fluidically connected by at least one damping duct, which is provided at least in portions in a duct shell arranged between the elastomer body and the outer sleeve.

### BACKGROUND

For example, mounts of this kind are used as a bushing mount for mounting wheel suspensions, engines, attachments, and units in motor vehicles. To provide improved damping over what can be achieved by purely elastomer damping, in particular during operation of motor vehicles of this kind in predetermined excitation frequency or amplitude ranges, the generic mount responds to corresponding excitations with hydraulic damping work, depending on the frequency. To do this, the at least two liquid chambers connected by a damping duct can be delimited in portions by elastomer expanding spring portions and elastomer suspension spring portions. Stress being applied to the mount results in damping liquid being diverted from one chamber into the other chamber via the damping duct and/or an associated expanding spring portion being expanded. The behavior of a mount of this kind is generally highly frequency-dependent, the damping frequently being determined substantially by the elastomer material at low excitation frequencies, while the flow resistance and thus the damping increase as excitation frequencies rise. As excitation frequencies rise further, the flow resistance of the damping liquid in the damping duct may be high enough that a fluid flow is prevented, and solely a respective expanding spring portion is expanded. Generally, the damping then decreases again as the excitation frequency rises further. A mount of this kind is also referred to as a hydraulic mount in this field.

A generic mount is disclosed in U.S. Pat. No. 9,038,997 B2, for example. In the generic hydraulic mount, the liquid chambers associated with one another are closed off on the outside by an upper and a lower mount core element, which are each provided with elastomer portions, while the chambers are separated by a third element. In this case, each of these elements comprises an elastomer portion, which is configured to adhere to an inner or outer part, respectively. The generic design of an axially damping hydraulic mount therefore requires at least three elements comprising adhering elastomer portions to form the elastomer body or the hydraulic mount of this type, meaning that, aside from the increased component costs, the assembly of the hydraulic mount of this type is also complex.

### SUMMARY

Accordingly, the problem addressed by the present invention is to provide a hydraulically damping mount in which at least some of the above-described drawbacks of the mount of this type are overcome. The present invention solves this problem by a hydraulically damping mount. The hydraulic mount according to the invention comprises a mount core extending in a longitudinal direction, an outer sleeve, and an elastomer body arranged radially between the mount core and the outer sleeve, the mount core and the elastomer body delimiting at least two liquid chambers that are associated with one another and are filled with a damping liquid, and the liquid chambers that are associated with one another being fluidically connected by at least one damping duct, and the damping duct being provided at least in portions in a duct shell arranged between the elastomer body and the outer sleeve, in particular in a duct shell arranged radially between the elastomer body and the outer sleeve. The hydraulic mount according to the invention is wherein, in the installation position of the hydraulic mount according to the invention, the mount core comprises at least two mount core elements that are in succession in the longitudinal direction, in particular at least two mount core elements that are in succession in the longitudinal direction and are oriented coaxially with one another, and, in a longitudinal section of the hydraulic mount, an associated, axially and radially extending elastomer suspension spring arm of the elastomer body and an axially and radially extending elastomer expanding spring arm of the elastomer body each extending from both mount core elements, and the duct shell being configured and designed to receive a respective free end portion of the expanding spring arms of the two mount core elements at least in portions to fix the free end portions of the expanding spring arms relative to one another. Receiving the two free end portions of the expanding spring arms of the two mount core elements at least in portions by means of the duct shell in this way can take place both in the axial direction and in the radial direction, i.e. the receptacle provided by the duct shell can extend in the axial direction and in the radial direction.

The designation that “an associated, axially and radially extending elastomer suspension spring arm of the elastomer body and an axially and radially extending elastomer expanding spring arm of the elastomer body each extending from both mount core elements” can mean that the respective suspension spring arm or expanding spring arm extends both with an extension component in the axial direction and also with an extension component in the radial direction of the mount.

The concept underlying the axially damping hydraulic mount according to the invention is to provide a hydraulic mount by joining at least two mount core elements together, each mount core element comprising a portion, in particular an axial portion of the elastomer body, such that the elastomer body of the mount according to the invention, in particular the entire elastomer body of the mount according to the invention, can be provided by joining together the at least two mount core elements. In particular, the hydraulic mount according to the invention can be formed by a two-part mount core comprising elastomer body parts fastened thereto, which reduces the manufacturing and assembly complexity of the hydraulic mount according to the invention in comparison with the generic mount. Both at least one suspension spring arm and at least one expanding spring arm can be arranged on or fastened to each of these axially successive mount core elements. Preferably, in the installation state of the mount, the suspension spring arm and expanding spring arm portions, which are associated with a mount core element in this way, can be arranged to be axially spaced apart from one another, relative to one another, over the majority of their radial extension.

In this case, the designation “suspension spring portion or suspension spring arm” can denote a portion of the elastomer body which substantially determines or substantially co-determines the static load-bearing capacity, while the designation “expanding spring portion or expanding spring arm” can denote a portion of the elastomer body that is elastically deformable by an operating load in order to provide a variable volume of at least one of the two liquid chambers associated with one another.

Developments of the invention and further advantageous features of the hydraulic mount according to the invention are set out in the following general description, the drawings, the description of the figures, and the dependent claims.

To provide response behavior of the hydraulic mount according to the invention that is symmetrical in a predetermined axial direction and in the opposite axial direction, it can expediently be provided that the expanding spring arm and the suspension spring arm of the respective mount core element extend axially in opposite directions, in particular over at least a respective extension of >50% of its total respective extension, and, in the installation state or assembled state of the hydraulic mount according to the invention, the two mount core elements being able to be oriented in succession and in particular coaxially with one another such that, in the longitudinal section of the mount, the expanding spring arms of the two mount core elements face one another and the two suspension spring arms face away from one another.

It can preferably be provided that the two mount core elements each comprising an associated suspension spring arm and expanding spring arm are constructed identically, meaning that the manufacturing costs can be reduced further.

To securely delimit the at least two liquid chambers within the hydraulic mount according to the invention, it can expediently be provided that, in the longitudinal section of the mount, the suspension spring arm associated with the respective mount core element and the expanding spring arm associated with the respective mount core element axially delimit a liquid chamber, associated therewith, of the at least two liquid chambers. This structural measure means that a first of the at least two mount core elements comprising the associated expanding spring arm and the associated suspension spring arm, in the longitudinal section of the mount, axially determines a first liquid chamber and the second mount core element, independently thereof, determines a second liquid chamber associated with the first liquid chamber.

Particularly expediently, it can be provided that the duct shell can provide a respective radial delimitation of the at least two, in particular the two, liquid chambers, the duct shell being able to be formed in multiple parts, in particular in multiple parts such as two parts. A two-part duct shell of this kind can in particular be formed in two parts by two half-shells in the circumferential direction, in one embodiment, each of the two half-shells being able to extend in the circumferential direction, i.e. perpendicularly to the axial direction, of the mount over approximately 180 degrees.

To fix a respective free end portion of the expanding spring arms of the two mount core elements, in the longitudinal section of the mount, it can be provided that the duct shell comprises an associated radial recess portion open toward the mount core for receiving a free end portion of the first expanding spring arm and an associated recess portion that is radially open toward the mount core for receiving a free end portion of the second expanding spring arm. In this case, these recess portions of the duct shell can be axially spaced apart from one another or can transition into one another.

In this respect, in a particularly expedient embodiment, it can also be provided that the duct shell, in the longitudinal section of the mount, comprises a recess which is open radially toward the inner core and is configured to simultaneously receive the free end portion of the expanding spring arm of one mount core element and the free end portion of the expanding spring arm of the other mount core element at least in portions, in particular such that both free end portions of the two expanding spring arms are arranged in this radial inwardly open recess in the duct shell, in particular so as to be axially pressed against one another under preload. It can be provided that the radial recess in the duct shell that is open toward the inner core in the longitudinal section of the mount is configured as a groove portion that is open radially toward the inner core, i.e. the open groove portion can in particular be configured as an annularly closed groove portion on the inside of the duct shell for receiving the free end portions of both expanding spring arms. In such embodiments comprising an annularly closed groove portion on the inside of the duct shell, the hydraulic mount according to the invention can be constructed to be rotationally symmetrical about the longitudinal axis at least in portions.

To optimize the hydraulic function of the axially damping hydraulic mount according to the invention, it can expediently be provided that, in the longitudinal section of the mount, delimiting surfaces of the two expanding spring arms each directed toward the associated mount core element and at least one delimiting surface of the mount core associated therewith form a closed cavity that is free of damping liquid. In this case, the delimiting surface of the mount core associated with the two expanding spring arms can be made up of the two delimiting surfaces of the two mount core elements, which face the respective expanding spring arm. This structural measure means that, in the longitudinal section of the mount, the expanding spring arms delimiting the respective liquid chamber are facing a cavity on the side opposite the respective liquid chamber, and this increases the flexibility when designing the respective expanding spring portion in terms of its movability and elastic deformability. Expediently, in the longitudinal section of the mount, the expanding spring arms can be designed such that this closed cavity that is free of damping liquid is positioned radially between the mount core or the mount core elements and the portions of the expanding spring arms that are spaced apart from the mount core.

To securely fix the free end portions of the elastomer expanding spring arms to the duct shell, in the longitudinal section of the hydraulic mount according to the invention, it can expediently be provided that at least one of the free end portions, in particular both free end portions of the elastomer expanding spring arms, comprises a respective hard insert. In such embodiments according to the invention in which an expanding spring arm associated with a respective mount core element extends over the entire circumference relative to the axial direction of the mount according to the invention, in particular rotationally symmetrically, the hard insert can be configured as a respective annular hard insert, the annular axis being able to extend coaxially with the axial axis of the mount.

This hard insert can for example comprise a plastics material, a composite material, and/or a metal material. In this case, it can preferably be provided that the hard insert is configured to have a hardness that is at least 3 times or 5 times, in particular at least 10 times, greater than the elastomer, the insert being able to be embedded in elastomer at least in portions, in particular completely. For example, the respective hardness can be a Shore hardness. It should be noted that the hardness of a metal material is conventionally not indicated in Shore hardness; the above explanation is intended to clarify that the hardness of the hard insert is at least 3 times or 5 times, in particular at least 10 times, greater than the hardness of the elastomer.

Depending on the embodiment, the respective hard insert of the expanding spring arm or portion can have a round, oval, or polygonal, in particular rectangular, cross section, which is designed to fit to the recess/receptacle open toward the mount core or the receiving groove in the duct shell, in particular such that, in the installation position, the free end portions of the two expanding spring arms, in their axial extension when taken together, where necessary taking into account or adding a thickness of an elastomer adherence on the hard inserts, for example correspond to the axial width of the recess/receptacle or receiving groove in the duct shell.

It can be provided that the hard inserts, in particular the two annular hard inserts, of the two free end portions of the expanding spring arms comprise a respective elastomer mass on their side facing the cavity to provide an elastomer buffer, which is configured to have an associated stop surface on the mount core to limit a radial deflection of the hydraulic mount according to the invention during its operation. Owing to this design, it can be ensured that the side of the end portions of the expanding spring arms which faces the mount core and to which the elastomer mass is applied hits an associated mount core portion during its relative radial deflection inward once a predetermined radial deflection of the mount core relative to the outer sleeve is exceeded, which can reliably prevent the occurrence of impermissible operating forces on critical elastomer portions of the mount, such as the expanding arm portions, which forces limit the service life of the mount according to the invention.

Expediently, in the longitudinal section of the mount, the elastomer suspension spring arm associated with a mount core element comprises a free end portion, which abuts the outer sleeve of the hydraulic mount according to the invention in the installation position. To increase the stability of the mount according to the invention in relation to operating forces, in particular axial operating forces, it can expediently be provided that the free end portion of the respective elastomer suspension spring arm associated with a mount core element comprises a hard insert embedded in elastomer at least in portions, preferably completely. In such embodiments according to the invention in which a suspension spring arm associated with the mount core element extends over the entire circumference relative to the axial direction of the mount according to the invention, in particular rotationally symmetrically, the hard insert can be configured as a respective annular hard insert, the annular axis of the hard insert being able to extend coaxially with the axial axis of the mount in the installation position. To provide symmetrical response behavior of the mount according to the invention in relation to a deflection in the axial direction and in the opposite axial direction, it can expediently be provided that the elastomer suspension spring arm associated with a respective mount core element comprises such a free end portion, in particular such a free end portion comprising a respective hard insert.

This hard insert can for example comprise a plastics material, a composite material, and/or a metal material. In this case, it can preferably be provided that the respective hard insert of the elastomer suspension spring arms is configured to have a hardness that is at least 3 times or 5 times, in particular at least 10 times, greater than the elastomer of the suspension spring arms, the insert being able to be embedded in elastomer at least in portions, in particular completely. For example, the respective hardness can be a Shore hardness. It should be noted that the hardness of a metal material is conventionally not indicated in Shore hardness; the above explanation of the hard insert of the respective elastomer suspension spring arm is intended to clarify that the hardness of the hard insert is at least 3 times or 5 times, in particular at least 10 times, greater than the hardness of the elastomer. Depending on the embodiment, on the side facing the outer sleeve, the respective hard insert of the elastomer suspension spring arm can have an approximately convex design in cross section, which for example can be made up of successive straight or planar portions that are angled relative to one another.

To securely delimit liquid chambers that are axially adjacent to one another, it can expediently be provided that, in the longitudinal section of the hydraulic mount according to the invention, the free end portions of the two elastomer expanding spring arms comprise a plurality of axial contact surfaces associated with one another, which are spaced apart from one another in the radial direction in the longitudinal section of the mount by at least one axial, circumferential recess. These recesses in the region of the axial abutment of the free end portions of the two elastomer expanding spring arms can provide free surfaces for compression of the elastomer in the region of the adjoining contact surfaces and in this respect can be used to seal axially successive liquid chambers. The designation “axial contact surfaces” means surfaces of which the surface normal extends substantially in parallel with the mount axis.

To fix the at least two mount core elements to one another which are in succession in the longitudinal direction and each comprise a suspension spring arm and an expanding spring arm fastened thereto, it can expediently be provided that the mount core elements comprise a respective coaxially extending hole in the installation position to receive a shared fastening bolt, in particular for simultaneously fastening the hydraulic mount to a component, in particular a component of a motor vehicle, and at the same time for fixing the mount core elements to a respectively associated elastomer body part. Axially successive mount core elements can each preferably have end faces associated with one another, which adjoin one another in the installation position and are interconnected by receiving and fixing a shared bolt through the coaxially extending holes in all the mount core elements.

To fix the two expanding spring arms in a recess in the duct shell associated therewith, in particular in a groove receptacle in the duct shell associated therewith and extending over the circumference relative to the mount axis, the end portions of the expanding spring arms of axially successive mount core elements can be oriented approximately perpendicularly to the longitudinal axis of the mount, i.e. radially.

To make it easier to axially move the expanding spring arms during operation of the hydraulic mount according to the invention by elastic deformation of the respective expanding spring arm, it can expediently be provided that the two expanding spring arms have an angle in the range of 20-45 degrees or in the range of 135-160 degrees relative to the longitudinal direction of the mount core, at least in portions. It can preferably be provided that the two expanding spring arms have an angle in the range of 30-35 degrees or 145-150 degrees relative to the longitudinal axis of the mount core in portions.

To ensure that end portions of the suspension spring arm portions are fixed relative to the outer sleeve even when high operating forces occur, it can expediently be provided that, in the longitudinal section of the hydraulic mount according to the invention, the free end portions of the suspension spring arms are arranged in the region of an associated end face of the outer sleeve. In this case, it can also be provided that the outer sleeve has respective shaping radially inward in the region of its two end faces to respectively radially encompass the end portion of an associated respective suspension spring arm. In particular in an embodiment in which the hydraulic mount according to the invention comprises two mount core elements in succession in the axial direction, in the longitudinal section of the mount, the suspension spring arm of one mount core element can be encompassed on a first of the two end faces of the outer sleeve and the suspension spring arm of the other mount core element of the two mount core elements can be encompassed on the other end face of the outer sleeve. It can preferably be provided that the shaping of the outer sleeve on its two end faces is fitted to the contour of the end portion of the respective suspension spring arm facing the outer sleeve such that, over the region of the shaping, an inner surface portion of the outer sleeve abuts the end portion of the respective suspension spring arm at least in portions, in particular substantially completely.

To limit the forces acting on the elastomer body, in particular on the elastomer expanding spring portions and the elastomer suspension spring portions of the elastomer body of the hydraulic mount according to the invention, during operation, it can expediently be provided that a radially outwardly extending stop element, in particular in the form of a stop disk, is arranged at least on an axial end portion of the mount core formed by the at least two mount core elements, which stop element comprises an elastomer mass extending in the axial direction on its side facing the elastomer body of the hydraulic mount according to the invention, said elastomer mass for example being in the form of an elastomer ring or an arrangement of circumferentially spaced elastomer islands, the elastomer mass being designed and configured to interact with the outer sleeve to limit a relative axial movement of the outer sleeve and the mount core.

The stop element can expediently be made of a hard material relative to the elastomer material, for example can comprise or be made of plastics material, a composite material, or a metal material. The elastomer mass, in particular the elastomer ring, can preferably be arranged in the region of a radial end portion of the stop element, which is configured for example as a stop disk, a predetermined axial spacing between the elastomer ring and a stop surface of the outer sleeve associated with the elastomer ring being formed when the mount is free of operating forces. The stop surface, provided by the outer sleeve, for the stop element on an end face of the outer sleeve can for example be formed by the above-described radial shaping of the outer sleeve in the region of an end face.

The stop element, in particular the stop disk, can expediently comprise a hole which is formed coaxially with the holes in the mount core elements in the installation position, the stop element abutting an end face of the mount core or an end face of an associated mount core element by a surface portion that encloses the hole in said stop element. In this case, it can be provided that the associated mount core element is configured to axially receive the stop element, for example by providing a receiving collar associated with the stop element or a projection in the region of the end surface of the mount core element.

Particularly advantageously, in particular to limit an axial deflection of the inner element and the outer sleeve in the two axial directions that are opposite one another, it can be provided that a radially outwardly extending stop element, in particular in the form of a stop disk, which comprises an elastomer mass, in particular in the form of an elastomer ring, on its side facing the elastomer body, which elastomer ring interacts with the outer sleeve as described above to provide a stop, is arranged on each of the two axial end portions of the mount core of the hydraulic mount according to the invention.

It can expediently be provided that the hydraulic mount according to the invention comprises exactly two mount core elements each comprising, in longitudinal section, an axially and radially extending elastomer suspension spring arm of the elastomer body fastened thereto and an axially and radially extending elastomer expanding spring arm of the elastomer body fastened thereto, the suspension spring arm and the expanding spring arm of the respective mount core element comprising a free end portion in each case. The expanding spring arm portion or expanding spring and the suspension spring portion or suspension spring can in particular be fastened to the respective mount core element by being vulcanized. In this case, the two mount core elements are rotated by 180° relative to one another, are arranged coaxially relative to one another, and, in the assembled state of the hydraulic mount according to the invention, hit one another at associated end surfaces, and are in particular interconnected by means of a bolt connection as set out above. In this embodiment, it can be provided that the mount core of the hydraulic mount according to the invention is formed by the two mount core elements and the elastomer body of the hydraulic mount according to the invention is formed by the above-described elastomer portions, which can comprise the above-described hard inserts at their respective free end portions where necessary, such that an elastomer part-body adheres to each of the mount core elements.

It can be provided that the mount core, assembled as described above, comprises an axial central portion and two outer portions each arranged to be axially on the outside of this axial central portion, the two expanding spring arms extending toward one another from the mount core in the central portion in the longitudinal section of the mount according to the invention so as to be axially spaced apart from one another, and a radially outwardly extending, in particular circumferential mount core bead, from which one of the suspension spring arms extends in each case, is formed axially between the central portion and the two outer portions of the mount core in each case.

It can be provided that the expanding spring arms and suspension spring arms formed in the longitudinal section of the mount according to the invention each extend over a predetermined circumferential portion, in particular over the entire circumference of the mount core. It can be provided that the hydraulic mount according to the invention is constructed to be rotationally symmetrical in the axial region of the assembled elastomer body. In this embodiment, it can be provided that the hard inserts of the end portions of at least one of the expanding spring portions and/or of at least one of the suspension spring portions, in particular of all the expanding spring portions and all the suspension spring arm portions, are configured to be annular in order to provide a hydraulic mount according to the invention that provides symmetrical damping in the radial direction.

The designation “mount core bead” or “bead” can generally mean a radial thickened portion, in particular extending over the entire circumference, over a predetermined axial region of the mount core. The designation “elastomer” can generally mean a synthetic rubber or rubber-like plastics material, the material keeping its shape yet being elastic and being slightly deformable in relation to the above-described hard inserts. Depending on the embodiment, the mount core of the hydraulic mount according to the invention or the mount core elements can be made of a metal material, such as aluminum or steel, but also can be made of a rigid plastics material that is not elastic in comparison with the elastomer of the elastomer body, but also can be made of a composite material. For example, in the context of the invention, a metal main cylinder body of a mount core element is also used to configure an injection of a plastics material in order to create the above-described mount core bead.

In an expedient embodiment of the hydraulic mount according to the invention, it can be configured as a bushing mount comprising a continuous hole for receiving a fastening element, such as a bolt, by means of which the hydraulic mount according to the invention can be fastened to a first component of a motor vehicle, for example, and a cylindrical outer sleeve, which can be inserted into a mount eye, associated with the mount, of a further component of the motor vehicle to establish a connection of said components of a motor vehicle while providing predetermined damping functionality.

In one embodiment of the hydraulic mount according to the invention in which the mount core is assembled by joining together two mount core elements, it can expediently be provided that the two suspension spring arms have an angle in the range of 50-60 degrees or in the range of 120-130 degrees, preferably approximately 55 or 125 degrees, relative to the longitudinal axis of the mount core when the mount according to the invention is free of operating forces.

Depending on the embodiment, expanding spring portions and/or suspension spring portions of the elastomer body can be connected, in particular materially bonded, to the associated mount core element by means of adhesion or vulcanization, in particular to convey operating forces between the outer sleeve and the core element of the hydraulic mount according to the invention in a slip-free manner.

### BRIEF DESCRIPTION OF THE DRAWINGS

The invention is explained in the following by describing an embodiment in addition to modifications to a hydraulic mount according to the invention, wherein:

FIG. 1 is a perspective longitudinal section through a hydraulic mount constructed according to the invention;

FIG. 2 is an exploded view of the hydraulic mount in FIG. 1;

FIG. 3 is an exploded view of a single mount element for forming the hydraulic mount according to the invention in FIG. 1;

FIG. 4 is a longitudinal section through the single mount element in FIG. 3;

FIG. 5 is a longitudinal section through the mount element in FIGS. 3 and 4 in the assembled state, with the duct half-shell attached; and

FIG. 6 is a front longitudinal section through the hydraulic mount in FIG. 1 formed according to the invention.

### DETAILED DESCRIPTION

The hydraulically damping mount (hydraulic mount) according to the invention described in the following can be used in a wide range of applications, for example in the field of commercial vehicles, in particular as a hydraulically damping rubber-metal mount or a hydraulically damping bushing mount. The mount according to the invention can for example be configured to mount engines, cabs, and attachments, but can also be used in the field of the wheel suspension of a vehicle, for example as a suspension link mount.

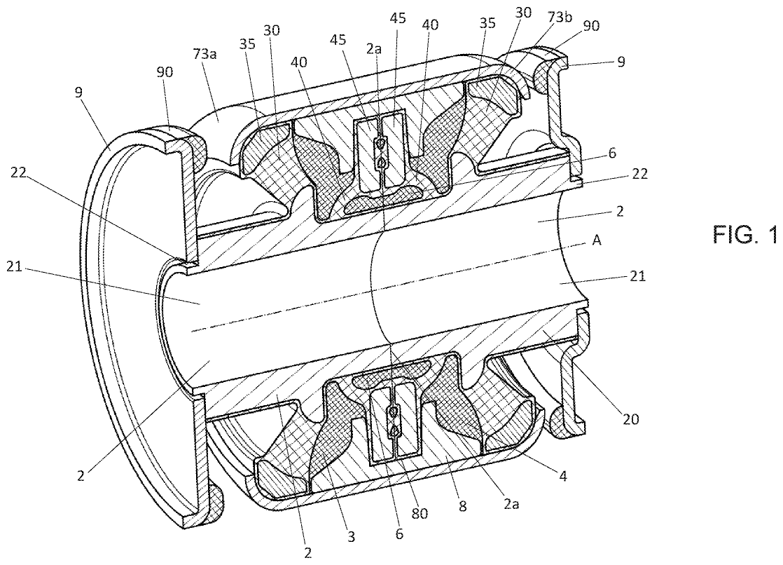

The mount according to the invention can comprise two identically constructed mount elements 2. FIG. 1 is a longitudinal section, relative to the mount axis A, through a mount of this kind, the two mount elements 2 adjoining one another at their end faces to be in contact at a respective boundary surface 2a.

In the embodiment described, each of the bearing elements 2 comprises a mount core element 20 comprising a respective inner hole 21, the inner holes 21 in both mount elements 2 being oriented to be coaxial with one another in the assembled state of the mount elements 2, such that the inner hole in the hydraulic mount 1 according to the invention is made up of the two inner holes 21 in the two mount elements 2. In this embodiment, the mount core of the mount 1 according to the invention comprises the two mount core elements 20 that are arranged one behind the other in the longitudinal direction and are oriented coaxially with one another.

As shown in FIG. 1, when assembled, the hydraulic mount 1 according to the invention can comprise a mount core formed by the two mount core elements 20, an outer sleeve 7 radially terminating the mount 1, and the elastomer body 5 arranged between the mount core 2 and the outer sleeve 7. In the embodiment described, the elastomer body 5 is made up of two elastomer part-bodies 50, which are each materially bonded to one of the mount elements 2, and this will be discussed in greater detail in the following.

In principle, each of the mount elements 2 can comprise an elastomer suspension spring portion 30 materially bonded to the associated mount core element 20. In the embodiment explained, the suspension spring portion 30 comprises, at a free end portion, an insert 35, which can comprise a material that is not elastic in comparison with the elastomer of the elastomer body, for example a hard plastics material or a metal material. This insert can be embedded in the elastomer material of the suspension spring portion 30 at least in portions, in particular also completely. Furthermore, each mount element 2 comprises an again radially and axially extending expanding spring portion 40, so as to be axially spaced apart from the suspension spring portion 30, which expanding spring portion is fastened to an outer lateral surface of the associated mount core element 20 in a materially bonded manner, in particular by vulcanization, and comprises a free end portion, in the same way as the suspension spring portion 30. At a free end portion, the expanding spring portion 40 can comprise an insert 45, which is similar or identical to the insert 35 of the suspension spring portion 30 in terms of this material and/or its physical properties.

As shown in FIG. 1, the mount elements 2, which are designed to be identical here, are arranged to be rotated by 180° relative to the mount axis A, such that contact surfaces or end surfaces of the mount core elements 20 associated with one another and contact surfaces of the end portions of the two expanding spring portions 40 associated with one another are in mutual contact with one another.

The end portions of the expanding spring portions 40 comprise the inserts 45 embedded in elastomer at least in portions, which inserts are approximately rectangular in the longitudinal section of the mount 1 shown in FIG. 1 and, in the longitudinal section of the mount 1, are received in a groove 80 in a duct shell 8 that is radial relative to the longitudinal direction of the respective mount core element 20.

In the embodiment described, this duct shell 8 can be configured to have two shells, each having a circumferential extension relative to the mount axis of approximately 180°, and is arranged radially between the elastomer body 5 and the outer sleeve 7. By receiving the two end portions 41, the duct shell 8 fixes the two expanding spring portions 40 in the region of their free ends, in particular in the longitudinal direction of the mount. As can be seen, chambers 3 and 4, which are delimited in the radial direction by the mount core element 20 of the respective mount element 2 and the duct shell 8, are determined in the axial direction by the expanding spring portion 40 and the suspension spring portion 30 of a respective mount element 2. The duct shell 8 further comprises radial openings to the liquid chambers 3, 4, which open into damping ducts, in order to fluidically connect both chambers 3, 4, such that damping work is performed within the at least one damping duct by the damping liquid flowing between the chambers in an operation-dependent manner.

Depending on the embodiment, a duct of this kind can be formed completely within the duct shell 8. It is, however, also possible to provide, on the side of the duct shell facing the outer sleeve 7, one or more recesses, in particular to configure them in the form of respective grooves, which then form the damping duct or damping ducts together with associated inner surface portions of the outer sleeve 7 in the assembled state of the hydraulic mount 1 according to the invention.

To stabilize the elastomer body of the hydraulic mount 1 according to the invention when axial operating forces occur, the outer sleeve 7 can comprise, in the region of its axial end faces, a respective shaped portion 73a, b radially inward for encompassing and axially supporting an associated end portion or the insert 35 of the respective suspension spring portion 30 of the associated mount element 2.

The expanding spring portions 40 that are in contact at their free end portions 41 in the installation position form, in the longitudinal section of the mount 1 in FIG. 1, a further, in particular closed cavity 6 that is free of damping liquid in one embodiment of the hydraulic mount 1 according to the invention together with an associated surface portion of the mount core, as a result of which the movability and elastic deformability of the two expanding spring portions can be improved to adjust predetermined frequency behavior of the hydraulic mount 1 according to the invention to external operating forces.

Depending on the embodiment, it can be provided that the respective suspension spring portions 30 and expanding spring portions 40 of the mount elements 2 and therefore also the associated liquid chambers 3, 4 are formed or extend over a predetermined circumferential portion of the mount. However, it is also possible according to the invention, as in the embodiment described in the drawings, for the liquid chambers 3, 4 to extend over the entire circumference of the mount core or the mount core elements 20, such that the suspension spring arms 30 or expanding spring arms 40 are annular in the longitudinal section in FIG. 1. In this embodiment, in this respect the inserts 35, 45 can also extend annularly around the mount axis A, and the same also applies in this respect to the liquid chambers 3, 4, such that, in this embodiment, the hydraulic mount 1 according to the invention comprises two axially separated liquid chambers 3, 4 extending over the entire circumference of the mount axis. The expanding spring portions 40 that are in contact at their free end portions 41 in the installation position also determine, in the longitudinal section of the mount 1, the further cavity 6, which is closed in this case, together with the associated surface portion of the mount core.

In the embodiment described, the mount according to the invention and shown in the drawings is configured as a mount hydraulically damping in the axial direction, in which, when the mount core and the outer sleeve 7 move relative to one another, the volume of one of the two liquid chambers 3, 4 is reduced and the volume of the other chamber 4, 3 is increased, such that the pressure differential brought about in both chambers causes damping liquid to be exchanged therebetween and damping work is performed by the hydraulic mount 1 according to the invention.

To limit the relative deflection of the mount core and the outer sleeve, it can be provided that a stop element 9 in the form of a stop disk, which comprises, on its side facing the elastomer body 5, an elastomer mass 90, which is formed for example by vulcanization and can be arranged radially in the region of the shaped portions 73a, b of the outer sleeve 7, is provided on one of the mount elements, or as indicated in FIG. 1, on both mount elements 2, 2 on the end face, there being, when no operating forces are applied, a predetermined axial spacing between the shaped portion 73a, b of the outer sleeve 7 and the elastomer mass 90 which, in this respect, corresponds to the maximum relative movement of the mount core and the outer sleeve in the two opposite axial directions.

To fasten a stop element 9, the respective mount core element 20 comprises a projection 22 on an end face facing the respective stop element, the stop element 9 being formed to comprise a hole which is adapted to the radial diameter of the projection such that the surface of the respective stop element 9 abuts an end face of the mount core element 20 and is radially held against the mount core element 20 by the projection.

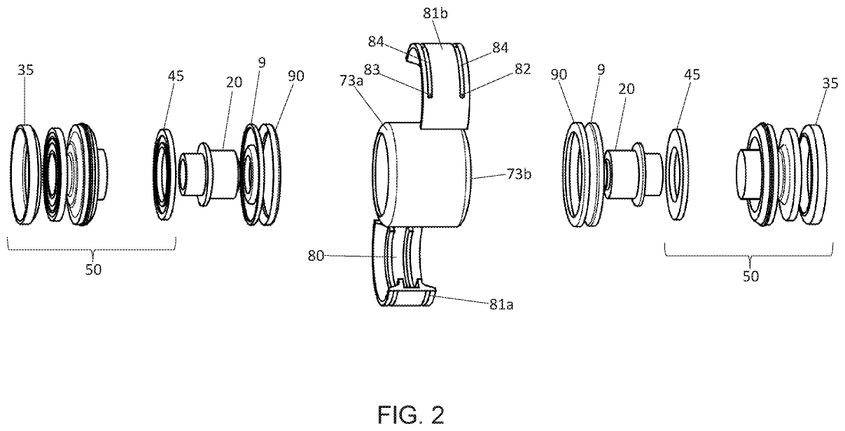

FIG. 2 is an exploded view of the hydraulic mount 1 according to the invention in FIG. 1, indicating the two elastomer part-bodies 50, which, in the embodiment described, are fixed to the associated mount core element 20 in a materially bonded manner and together form the elastomer body 5 of the hydraulic mount 1 according to the invention. FIG. 2 also shows the two half-shells 81a, b of the duct shell, which, in the installation position, each form or provide a receiving groove 80 indicated in FIG. 1 to receive and fix the end portions 41 of the expanding spring portions 40. Furthermore, the view of the duct half-shell 81b at the top in FIG. 2 shows the radial leadthroughs 82, 83, which open into a groove 84 which is formed on the outside of the respective duct half-shell 81b and connects these leadthroughs 82, 83, which, together with associated surface portions of the inner lateral surface 70 of the outer sleeve 7, provide the above-described damping duct in order to exchange damping liquid between the liquid chambers 3, 4.

In the installation position of the components of the hydraulic mount 1 according to the invention, the leadthrough 82 is axially at the level of the liquid chamber 4, while the leadthrough 83 is at the axial level of the liquid chamber 3, such that the half-shell 81b provides a single damping duct between the two liquid chambers 3, 4. In the embodiment described, the second half-shell 81a can be configured to be identical to the first-described half-shell 81b, such that, in this case, the hydraulic mount 1 according to the invention comprises two damping ducts between the two liquid chambers 3, 4 arranged axially one above the other.

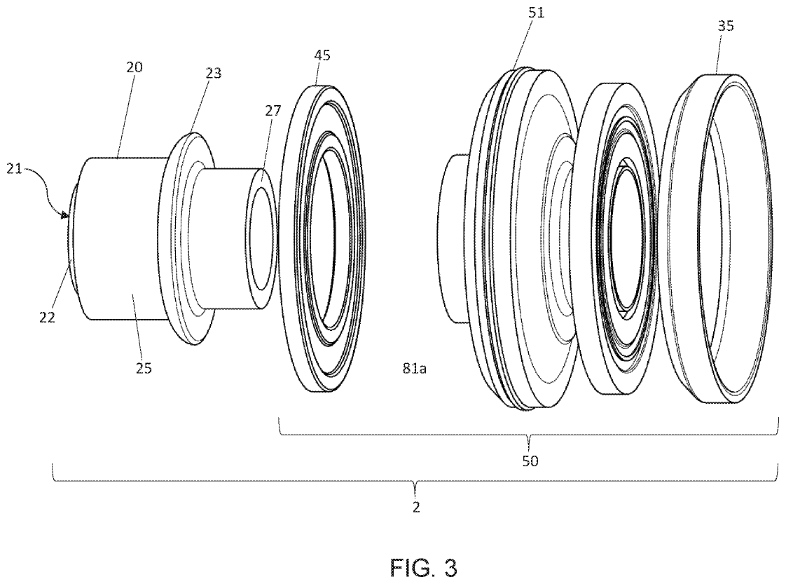

FIG. 3 shows one of the two mount elements 2 of the hydraulic mount 1 in FIGS. 1 and 2 according to the invention. The mount element 2 comprises a mount core element 20 and the elastomer part-body 50, which, in this embodiment, is again made up of the inserts 35, 45, which are annular in this case, and the elastomer form 51, which solely comprises elastomer. The elastomer part-body 50 is vulcanized onto the mount core element 20. In principle, the mount core element 20 is cylinder-like, having cylinder portions which extend in the axial direction at least in portions and axially continuously comprise a hole having a predetermined internal diameter, but optionally have a different diameter on their outer lateral surfaces.

In the embodiment described, the mount core element 20 can comprise a contact surface 27 on an end face for abutting an associated contact surface 27 of a further mount core element 20, while the mount core element 20 can comprise the already-described projection 22 on the end face opposite the contact surface in order to receive a stop element 9; see FIG. 1. Between the cylinder portions, which are graduated in terms of the external diameter, the mount core element 20 can comprise a circumferential mount core bead or a radial thickened portion 23 which extends radially over the cylinder portion facing the projection 22 on one of the end faces of the mount core element 20.

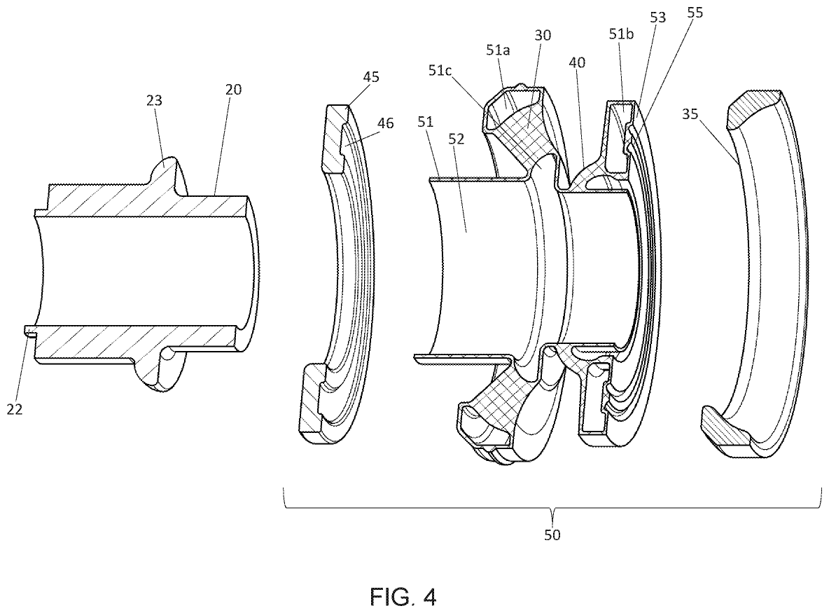

FIG. 4 is a longitudinal section through the view in FIG. 3 to explain the construction of the elastomer part-body 50. As can be seen, in the embodiment of the hydraulic mount 1 according to the invention described, the elastomer form 51 of the elastomer part-body 50 comprises, in each case, a closed cavity 51a for receiving the insert 35 of the suspension spring portion 30 (see FIG. 1) and a cavity 51b of the expanding spring portion 40 for receiving the annular insert 45. Furthermore, the elastomer form 51 comprises, on its inner surface 52, a radially inwardly extending groove 51c for receiving the mount core bead or thickened portion 23 of the mount core element. The elastomer form 51 further comprises an annular axial contact surface 53 on its end face facing away from the projection 22 in the installation position, and this will be discussed in greater detail below.

In the embodiment described, the elastomer form 51 is vulcanized to the outer lateral surface of the mount core element 20 by its inner surface 52, and in this respect is materially bonded thereto. While the insert ring 45 of the expanding spring portion 40 can be configured to be approximately rectangular in the cross section shown, the insert ring 35 of the suspension spring portion 30 can be configured to be approximately triangular in cross section. The insert ring 45 on the end portion 41 of the expanding spring portion 40 comprises an axial recess 46 on its axial end surface to provide structuring of the contact surface 53 of the elastomer form 51 in order to form an annular, elastomer sealing lip 55, which is radially delimited by annular free surfaces or axial recesses 54a, b.

The insert ring 35 that is approximately triangular in cross section in the region of the end portion 31 of the suspension spring portion 30 can be curved and adapted to the curvature of the respective shaped portion 73a, b in the region of its outer surface, which is encompassed by the shaped portion 73a, b of the outer sleeve in the installation position.

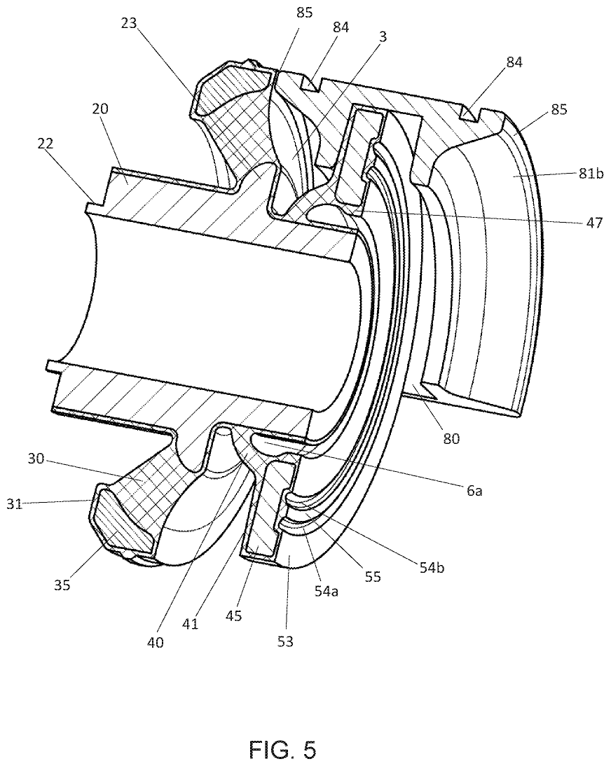

FIG. 5 again shows the longitudinal section of one of the two mount elements 2 with a duct half-shell 81b attached to illustrate the interaction of a respective mount element 2 with the duct shell 8; see FIG. 1. The duct shell 8 or the duct half-shells 81a, b comprise axial end surfaces 85 which are configured to abut an associated end surface of the end portion 41 of an expanding spring portion 40, such that a respective liquid chamber, in this case the liquid chamber 3, which is axially delimited by the suspension spring portion 30 and the expanding spring portion 40 of the respective mount element 2, is delimited in the radial direction such that a circumferential liquid chamber is formed in the embodiment described.

In this case, the end portion 41 of the expanding spring portion 40 is received in the circumferential receptacle or groove 80 in the duct shell 8 at least in portions. As shown in FIG. 5, on its axially inner end face, the end portion 41 of the expanding spring portion 40 comprises a substantially planar contact surface, which abuts an associated groove side surface of the receptacle 80 of the duct shell, while the end portion 41 of the expanding spring portion 40 comprises structuring on its outer end surface, configured as a contact surface 53, in order to seal to the end portion 41 of the expanding spring portion 40 of the second mount element 2, which is received in the receptacle or groove 80 in the duct shell 8 in the same way and, by its contact surface 53, abuts the contact surface 53 of the mount element 2 indicated in FIG. 5 (see also FIG. 1) in which both end portions 41 are received in the receptacle 80 of the duct shell 8 in mutual abutment.

In the embodiment indicated, the contact surface 53 of the respective end portions 41 of the expanding spring portions 40 comprises a circumferential sealing lip 55, which is delimited by circumferential free surfaces or axial recesses 54a, b in this case. Furthermore, the view in FIG. 5 shows the partial space 6a formed between the mount core element 20 and the expanding spring portion 40, which partial space forms the above-described cavity 6 together with the partial space of the second mount element 2 in the installation position of the two mount elements 2. On its side facing the mount core element 20, the end portion 41 of the expanding spring portion 40 comprises an elastomer mass to form an elastomer stop 47, which interacts with an associated outer lateral portion of the mount core element 20 to limit the radial relative deflection between the mount core element and the outer sleeve 7; see FIG. 1.

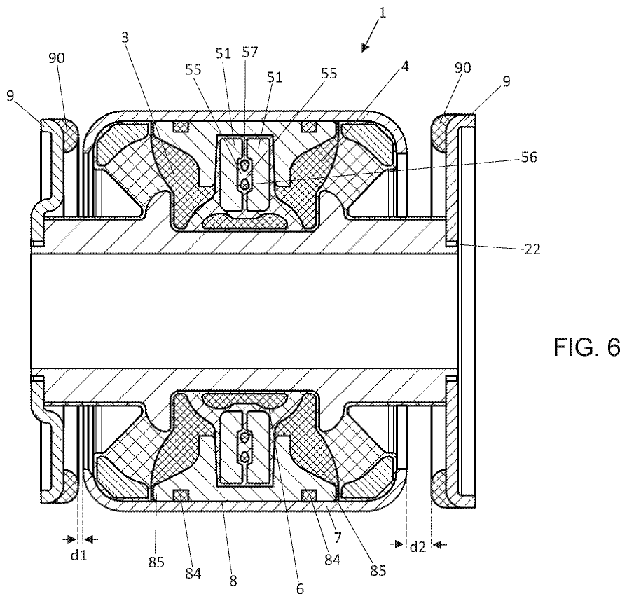

FIG. 6 is a front sectional view of FIG. 1 showing the mount 1 according to the invention. As can be seen, the sealing lips 55 arranged on the axially outer end face of the end portions 41 of the expanding spring portions 40 of both mount elements 2 lie on one another and securely seal the cavity 6 against the ingress of damping liquid from the two liquid chambers 3, 4. To do this, it can be provided that the two adjoining end portions 41 are received in the receptacle 80 of the duct shell 8 under axial preload such that the sealing lips 55 associated with one another are pressed against one another. In the embodiment described, the two sealing lips 55 are delimited by two annular cavities 56, 57 lying radially one above the other, which are formed by the axial recesses 54a, b on the end portions of the two expanding spring portions 40; see FIG. 5.

In the embodiment shown, the mount according to the invention is configured such that a relative deflection of the mount core toward the outer sleeve 7 is limited differently in the two opposite axial directions. This is achieved by the present different axial spacings d1, d2 between the respective elastomer ring 90 and the stop surfaces of the outer sleeve 7 that are associated therewith and are provided by the respective shaped portion 73a, b when the mount according to the invention is free of operating forces.

### List of Reference Signs

1 Hydraulically damping mount (hydraulic mount)
2 Mount element
2a Boundary surface
3 Liquid chamber
4 Liquid chamber
5 Elastomer body
6 Cavity
6a, b Partial space
7 Outer sleeve
8 Duct shell
9 Stop element
20 Mount core element
21 Inner hole/hole
22 Projection
23 Mount core bead/radial thickened portion
25 Outer lateral surface
27 Contact surface
30 Suspension spring portion/suspension spring arm
31 End portion
35 Insert/insert ring
40 Expanding spring portion/expanding spring arm
41 End portion
45 Insert/insert ring
46 Axial recess
47 Elastomer stop
50 Elastomer part-body
51 Elastomer form
51a, b Cavity
51c Groove
52 Inner surface
53 Contact surface
54a, b Annular free surface/axial recess
55 Sealing lip
70 Inner lateral surface
71 Outer lateral surface
73a, b Shaped portion
80 Receptacle/receiving groove
81a, b Half-shell/duct half-shell
82 Leadthrough
83 Leadthrough
84 Groove
85 Axial contact surface
90 Elastomer ring/elastomer mass
A Mount axis
d1, d2 Axial spacing

What is claimed is:

1. An axially damping hydraulic mount, comprising a mount core extending in a longitudinal direction, an outer sleeve, and an elastomer body arranged radially between the mount core and the outer sleeve, the mount core and the elastomer body delimiting at least two liquid chambers that are associated with one another and are filled with a damping liquid, and the liquid chambers that are associated with one another being fluidically connected by at least one damping duct, which is provided at least in portions in a duct shell arranged between the elastomer body and the outer sleeve, wherein the mount core comprises at least two mount core elements that are in succession in the longitudinal direction, and, in a longitudinal section of the hydraulic mount, an associated, axially and radially extending elastomer suspension spring arm of the elastomer body and an axially and radially extending elastomer expanding spring arm of the elastomer body each extending from both mount core elements, and the duct shell being configured and designed to receive a respective free end portion of the expanding spring arms of the two mount core elements at least in portions to fix the free end portions of the expanding spring arms relative to one another.

2. The axially damping hydraulic mount according to claim 1, wherein the expanding spring arm and the suspension spring arm of the respective mount core element extend axially in opposite directions.

3. The axially damping hydraulic mount according to claim 1, wherein, in the longitudinal section of the mount, the suspension spring arm associated with the respective mount core element and the expanding spring arm associated with the respective mount core element axially delimit a liquid chamber, associated therewith, of the at least two liquid chambers.

4. The axially damping hydraulic mount according to claim 1, wherein the duct shell comprises a receptacle or groove which is open radially toward the inner core and is configured to simultaneously receive the free end portions of the two expanding spring arms of the two mount core elements, in particular such that both free end portions of the two expanding spring arms of the two mount core elements are axially pressed against one another under preload.

5. The axially damping hydraulic mount according to claim 1, wherein delimiting surfaces of the two expanding spring arms directed toward the mount core and at least one delimiting surface of the mount core associated therewith form a closed cavity that is free of damping liquid.

6. The axially damping hydraulic mount according to claim 1, wherein at least one of the free end portions, in particular both free end portions of the elastomer expanding spring arms, comprise a respective insert, which is embedded in elastomer at least in portions, in particular an annular insert.

7. The axially damping hydraulic mount according to claim 1, wherein, in the longitudinal section of the mount, the elastomer suspension spring arm associated with a mount core element comprises a free end portion, which abuts the outer sleeve in the installation position, the free end portion of the elastomer suspension spring arm preferably comprising an insert embedded in elastomer at least in portions, in particular an annular insert.

8. The axially damping hydraulic mount according to claim 1, wherein the free end portions of the two elastomer expanding spring arms comprise a plurality of axial contact surfaces associated with one another, which are separated in the radial direction in the longitudinal section of the mount by at least one axial, circumferential recess, in particular by a plurality of axial, circumferential recesses, which are spaced apart radially from one another to form a sealing lip.

9. The axially damping hydraulic mount according to claim 1, wherein the at least two mount core elements comprise holes which extend coaxially with one another in the installation position to receive a shared fastening bolt for fastening the hydraulic mount to a component, in particular a component of a motor vehicle, and for fixing the at least two mount core elements to one another.

10. The axially damping hydraulic mount according to claim 1, wherein the two expanding spring arms have an angle in the range of 20-45 degrees or in the range of 135-160 degrees relative to the longitudinal axis of the mount core, at least in portions.

11. The axially damping hydraulic mount according to claim 1, wherein the outer sleeve is configured to radially encompass the respective suspension spring arm of the two mount core elements, in particular to radially encompass the end portion of the respective suspension spring arm of the two mount core elements.

12. The axially damping hydraulic mount according to claim 1, wherein a radially outwardly extending stop element is provided at least on an axial end portion of the mount core and comprises an elastomer mass on its side facing the elastomer body, in order to interact with an associated stop surface, arranged on an end face of the outer sleeve, to limit a relative movement of the outer sleeve and the inner core of the hydraulic mount relative to one another.

13. The axially damping hydraulic mount according to claim 1, wherein, in the longitudinal section of the mount, the mount core comprises an axial central portion and two outer portions each arranged to be axially on the outside of said central portion, the two expanding spring arms extending in the central portion so as to be axially spaced apart from one another, and a radially outwardly extending mount core thickened portion, from which one of the elastomer suspension spring arms extends in each case, is formed axially between the central portion and the two outer portions of the mount core in each case.

14. The axially damping hydraulic mount according to claim 1, wherein the two suspension spring arms have an angle in the range of 50-60 degrees or in the range of 120-130 degrees relative to the longitudinal axis of the mount core.

15. The axially damping hydraulic mount according to claim 1, wherein the expanding spring arm and/or the suspension spring arm are materially bonded to the respective associated mount core element.
